(19) United States
(12) Patent Application Publication
(10) Pub. No.: US 2012/0207610 A1
(43) Pub. Date: Aug. 16, 2012

(54) WIND TURBINE BLADE

(75) Inventors: Meihua Yu, Mattawan, MI (US); Jieting Zhang, Foshan (CN)

(73) Assignee: SEPSTAR, INC., Mattawan, MI (US)

(21) Appl. No.: 13/501,483

(22) PCT Filed: Nov. 2, 2010
(86) PCT No.: PCT/US2010/055047

§ 371 Date: Apr. 12, 2012

Related U.S. Application Data
(60) Provisional application No. 61/257,564, filed on Nov. 3, 2009.

(51) Int. Cl. F03D 11/00

(52) U.S. Cl. 416/223 R

(57) ABSTRACT

A wind turbine blade is provided which includes a root section, a transition section, a conventional section and a tip section. The root section may include a chord length that is greater than a chord length calculated using conventional equations by a factor of approximately 1.3. The root section may also include a blade setting angle that is greater than a blade setting angle calculated using conventional equations by a factor of approximately 1.3. The conventional section may include a chord length and/or a blade setting angle that is approximately equal to a chord length and/or a blade setting angle calculated using conventional equations. In the transition section, the chord length and/or blade setting angle may transition from the chord length and/or blade setting angle in the root section to the chord length and/or blade setting angle in the conventional section. The tip section may include a winglet.

### BACKGROUND OF THE INVENTION

The present invention relates to wind turbines and more particularly to wind turbine blades.

Wind turbines have been used to convert kinetic energy from the wind into useable energy for many years. During the recent push toward renewable energy, the demand for wind turbines has steadily risen. This has resulted in an increase of commercial wind farms that generate sufficient power to supplement the electricity requirements for entire cities. These wind farms include many wind turbines spread over a large area in a pattern to maximize the amount of energy that may be extracted from the wind. Commercial wind turbine used in these applications are designed for placement in high-wind areas, namely deserts, farms, and other open areas where they will experience sustained high winds for extended periods of time. The resulting designs for these wind turbines therefore include attributes that allow them to operate most efficiently during these high-wind periods.

The most recent developments in wind power generation have included non-commercial designs. Individuals are utilizing wind turbines to supplement their personal electrical needs. These residential users typically live in more populated, low-wind areas, as compared to commercial wind farms. As residential wind turbine operation has increased, shortcomings of the use of current commercial designs in residential applications have surfaced. One problem with current wind turbine designs is that they are designed for a relatively high-wind startup, meaning they require a high wind velocity before the wind turbine will be able to overcome its internal friction and the blades will begin to turn. In a residential setting, the wind velocity may rarely rise above the required start-up speed for most current wind turbine designs. The result is that the wind turbine blades stand idle while wind passes over them. A second problem with current wind turbine blade designs is that they are relatively inefficient. A third problem is the noise associated with current wind turbine designs. As air rushes past the wind turbine blades, the friction between the air and the blade surface creates noise. This has not presented a significant problem to this point because the majority of wind turbines have been operated in commercial settings, located far from populated areas. As more wind turbines are built close to populated areas, this noise has become a significant concern both for operators of wind turbines and their neighbors.

### SUMMARY OF THE INVENTION

The aforementioned problems are overcome in the present invention in which a wind turbine blade design provides for efficient and quiet blade operation while lowering the wind velocity necessary for start-up. The blade includes a root section, a transition section, a conventional section and a tip section. The conventional section includes a cross section similar to a NACA 4415 airfoil. The tip section is turned at a 35 degree angle rearward relative to the plane of rotation of the blade. The root section includes a chord length greater than a chord length calculated using conventional formulas by a factor of approximately 1.3. The blade setting angle of the root section is greater than a blade setting angle calculated using conventional formulas by a factor of approximately 1.3.

The present invention has distinct advantages over prior art wind turbine blades. First, the root section may provide a lower wind velocity required for start-up than current wind turbines require. Second, the tip section may allow for quieter operation of the wind turbine, as well as increased efficiency.

These and other objects, advantages, and features of the invention will be more fully understood and appreciated by reference to the description of the current embodiment and the drawings.

### BRIEF DESCRIPTION OF THE DRAWINGS

FIG. 1 is a top plan view of an embodiment of the wind turbine blade of the present invention;

FIG. 2 is a side view of the embodiment of FIG. 1;

FIG. 3 is a side view of the embodiment of FIG. 1;

FIG. 4 is a perspective view of the embodiment of FIG. 1;

FIG. 5 is a side view of the NACA 4415 airfoil;

FIG. 6 is a side view of the NACA 4415 airfoil;

FIG. 7. is a perspective view of a wind turbine that includes blades of the present invention;

FIG. 8 is a graph of the incoming air angle over the span of three blade designs;

FIG. 9. is a graph of the blade setting angle over the span of eight blade designs;

FIG. 10 is a graph of the chord length over the span of three blade designs; and

FIG. 11 is a graph of the angle of attack over the span of two blade designs.

### DESCRIPTION OF THE CURRENT EMBODIMENT

An embodiment of the wind turbine blade of the current invention is illustrated in the drawings and generally designated 10. The wind turbine blade 10 includes a tip section 30, a middle section 50, and a root section 70. The wind turbine blade 10 includes an attachment section 100 for fastening the blade to a hub 150 and a span 130 from the tip section 30 to the attachment section 100.

The wind turbine blade 10 includes a top surface 12 and a bottom surface 14, as perhaps best shown in FIG. 2. The blade 10 includes a parabolic leading edge 16 and a trailing edge 18, as perhaps best shown in the exemplary side view of the NACA 4415 airfoil in FIG. 5. The wind turbine blade 10 includes a chord line 20 connecting the leading edge 16 and the trailing edge 18, with associated chord length 22, shown in the exemplary side view of the NACA 4415 airfoil in FIG. 5.

A variable distance 24 from the leading edge 16 to a point along the chord line 20 is shown in FIG. 5. Also shown in FIG. 5 are variable distances 26 and 28. Variable distance 26 is the distance between the chord line 20 and the top surface 12, perpendicular to the chord line 20, at the variable distance along the chord line 24. Variable distance 28 is the distance between the chord line 20 and the bottom surface 14, perpendicular to the chord line 20, at the variable distance along the chord line 24.

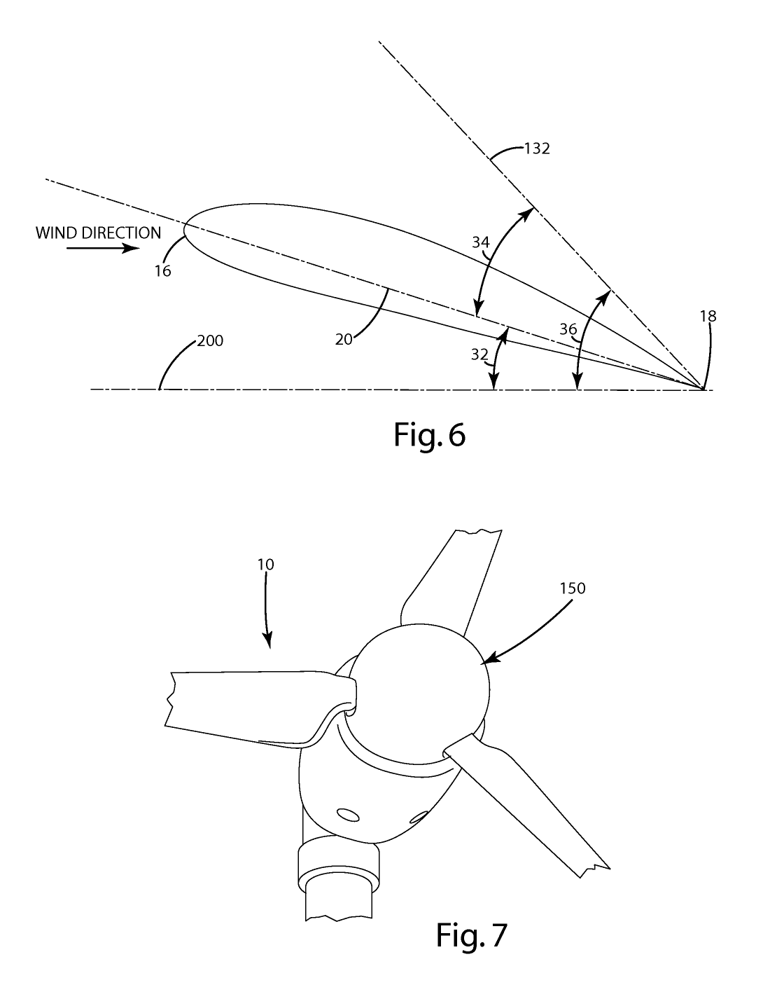

Turning to FIG. 6, an angle of attack 32 is formed between the chord line 20 (shown extended in FIG. 6) and the incoming wind direction 200. In operation, the wind turbine blade 10 rotates about a hub 150 (shown in FIG. 7) and creates a plane of rotation 132 in which the middle and root sections of the blade 50 and 70 rotate (shown perhaps best in FIG. 3). Returning to FIG. 6, a blade setting angle 34 is formed between the plane of rotation 132 and the chord line 20. An incoming air angle 36 is formed between the plane of rotation 132 and the wind direction 200.

The wind turbine blade 10 in FIG. 3 further includes references to various locations on the blade that are positioned at a certain fraction of the total span 130 of the blade. Beginning at the attachment section 100, the point at 10% of the span of the blade is labeled 52, 15% is labeled 54, 35% is labeled 56, 40% is labeled 58, 50% is labeled 60, 65% is labeled 62, 95% is labeled 64, and the end of the blade is labeled 66.

The wind turbine blade 10 is based on the NACA 4415 airfoil design, shown in FIG. 5. Table 1 below provides the design data for the NACA 4415, made dimensionless by dividing all values by the chord length 22. Table 1 includes the variable distance 24 along the chord line 20 divided by the chord length 22 (labeled X/C). Table 1 also includes the corresponding distance 26 between the chord line 20 and the top surface 12 at the variable distance 24 divided by the chord length 22 (labeled Y1/C). Table 1 further includes the corresponding distance 28 between the chord line 20 and the bottom surface 14 at the variable distance 24, divided by the chord length 22 (labeled Y2/C).

TABLE 1
NACA 4415 Data

| X/C | Y1/C | Y2/C |
|---|---|---|
| 1.00000 | 0.00000 | 0.00000 |
| 0.99893 | 0.00039 | −0.00011 |
| 0.99572 | 0.00156 | −0.00042 |
| 0.99039 | 0.00349 | −0.00092 |
| 0.98296 | 0.0061 | −0.00156 |
| 0.97347 | 0.00932 | −0.00227 |
| 0.96194 | 0.01303 | −0.00297 |
| 0.94844 | 0.01716 | −0.00364 |
| 0.93301 | 0.02166 | −0.00431 |
| 0.91573 | 0.02652 | −0.00502 |
| 0.89668 | 0.03171 | −0.00583 |
| 0.87592 | 0.03717 | −0.00674 |
| 0.85355 | 0.04283 | −0.00775 |
| 0.82967 | 0.04863 | −0.00886 |
| 0.80438 | 0.05453 | −0.01006 |
| 0.77779 | 0.06048 | −0.01136 |
| 0.75 | 0.06642 | −0.01277 |
| 0.72114 | 0.07227 | −0.0143 |
| 0.69134 | 0.07795 | −0.01596 |
| 0.66072 | 0.08341 | −0.01772 |
| 0.62941 | 0.08858 | −0.01958 |
| 0.59755 | 0.09341 | −0.02149 |
| 0.56526 | 0.09785 | −0.0234 |
| 0.5327 | 0.10185 | −0.02529 |
| 0.5 | 0.10538 | −0.02713 |
| 0.4673 | 0.10837 | −0.02891 |
| 0.43474 | 0.11076 | −0.03063 |
| 0.40245 | 0.11248 | −0.03229 |
| 0.37059 | 0.11345 | −0.0339 |
| 0.33928 | 0.11361 | −0.03547 |
| 0.30866 | 0.11294 | −0.037 |
| 0.27886 | 0.11141 | −0.03845 |
| 0.25 | 0.10903 | −0.03974 |
| 0.22221 | 0.10584 | −0.04078 |
| 0.19562 | 0.1019 | −0.04147 |
| 0.17033 | 0.09726 | −0.04177 |
| 0.14645 | 0.09195 | −0.04166 |
| 0.12408 | 0.08607 | −0.04106 |
| 0.10332 | 0.0797 | −0.03991 |
| 0.08427 | 0.07283 | −0.03817 |
| 0.06699 | 0.06541 | −0.03582 |
| 0.05156 | 0.05753 | −0.03281 |
| 0.03806 | 0.04937 | −0.02915 |
| 0.02653 | 0.04118 | −0.02502 |
| 0.01704 | 0.03303 | −0.02061 |
| 0.00961 | 0.02489 | −0.0159 |
| 0.00428 | 0.01654 | −0.01102 |
| 0.00107 | 0.00825 | −0.00566 |
| 0.00000 | 0.00075 | 0.00075 |

An example of using conventional calculations to determine the proper chord length 22 and blade setting angle 34 for various cross sections of a wind turbine blade will now be described in detail. A formula relating the power output to the blade span is:

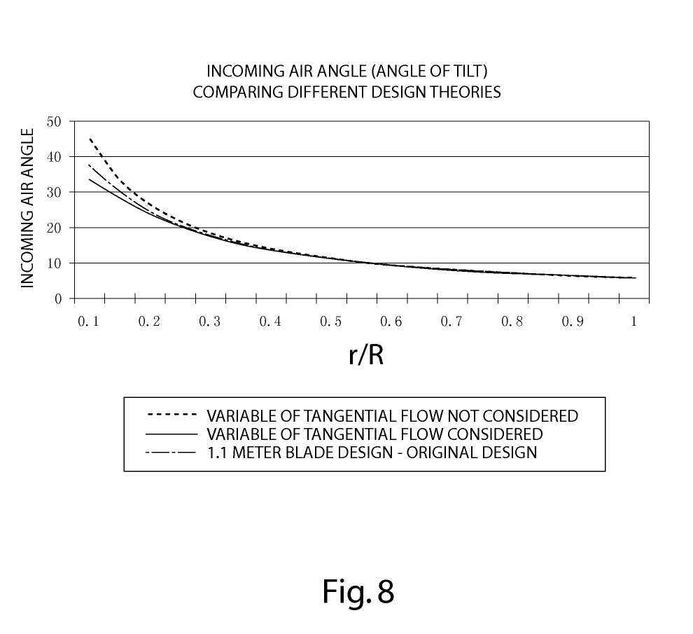

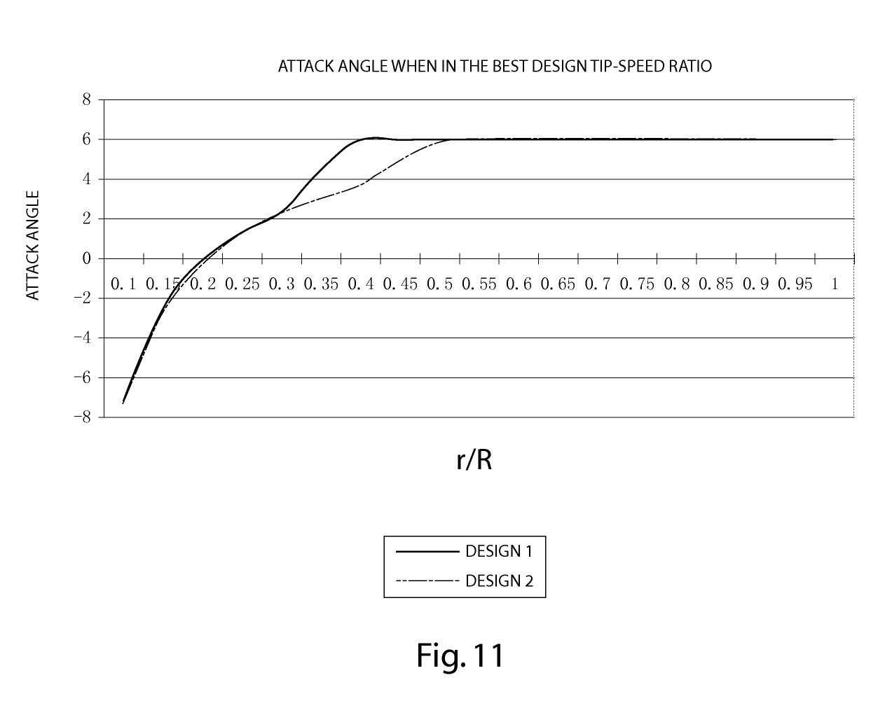

P=0.5*Cₚ*ρ*π*R²*V³

where P is the desired power output, Cₚ is the power factor (ratio of the wind energy transferred to mechanical energy), ρ is the air density, R is the radius (span) of the blade, and V is the wind speed. From the above equation, the blade span 130 may be determined. Once the blade span 130 is determined, the incoming air angle 36 may be selected based on known conventional models for each section of the blade 10. A graph of the incoming air angle 36 for three designs, including an embodiment of the present invention is shown in FIG. 8. After the incoming air angle is determined, the angle of attack 32 may be chosen depending on the desired lift force of the blade. Generally, the greater the angle of attack 32, the greater the lift force of the blade. However, as the angle of attack 32 increases past a critical point, a stall is induced and the lift force decreases as the angle of attack 32 increases. Additionally, a wind turbine may run more efficiently when its blades are positioned at a certain angle of attack 32. A graph of the angle of attack 32 of several blade designs, including embodiments of the present invention is shown in FIG. 11 and will be described later in the specification. Once the angle of attack 32 is selected, the blade setting angle 34 may be calculated using the formula:

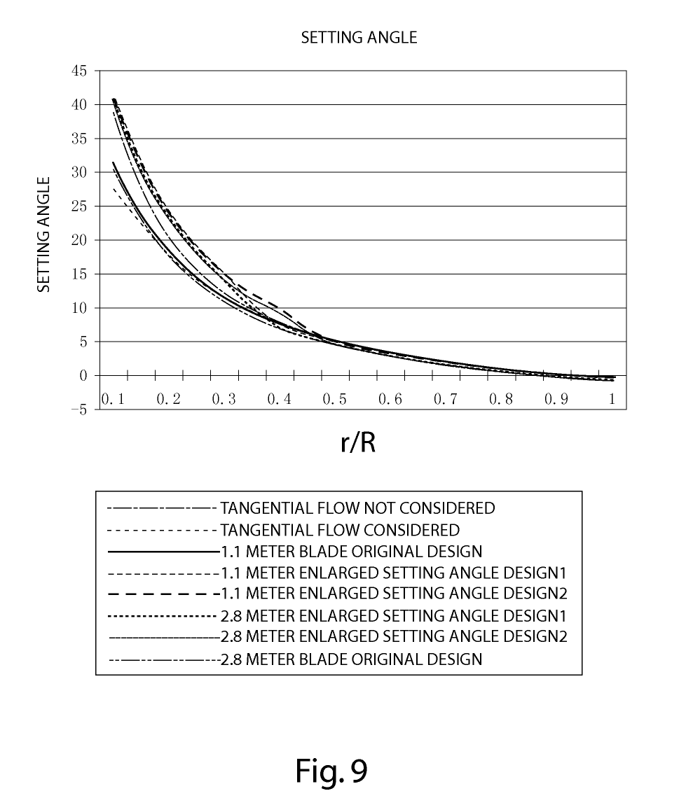

α=I−i

where α is the blade setting angle, I is the incoming air angle, and i is the angle of attack of the blade. A graph of the blade setting angle 34 of various blade designs, including embodiments of the present invention is shown in FIG. 9 and will be described later in the specification.

Once the blade setting angle 34 and angle of attack 32 are known, the tip-speed ratio may be calculated. The tip-speed ratio is the ratio of the linear tip-speed to the incoming wind speed. The tip-speed ratio may be calculated using the formula:

α=arctan(2/3/γ*r/(1+2/9/γ*r²))−i

where α is the blade setting angle, i is the angle of attack of the blade, and r is the blade cross section location in terms of distance from the rotor. Using the tip-speed ratio, the chord length 22 may then be calculated using the following Wilson equation:

L_{C}=(16*π/9)R/{C_{L}*b*γ*[(γ²*r²/R²)+(4/9)]⁻²}

where L_{C} is the chord length, R is the rotor radius (blade span), r is the blade cross section location in terms of distance from the rotor, γ is the tip-speed ratio, C_{L} is the lift coefficient and b is the number of blades. Optionally, the chord length 22 may be calculated using the formula:

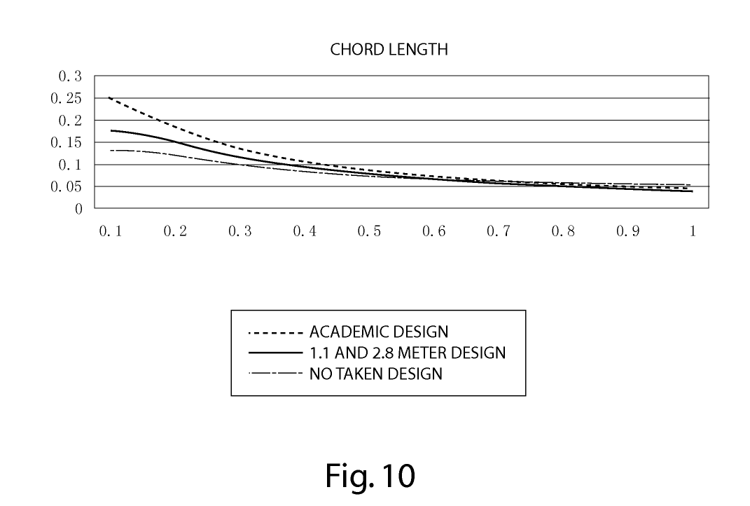

L=C_{L}*L_{C}*A

where L is the lift force, C_{L} is the lift coefficient, c is the chord length, and A is the surface area of the blade. A graph of the chord length 22 of three blade designs, including embodiments of the present invention, is shown in FIG. 10.

The chord length 22 and setting angle 34 calculated using the attributes of the NACA 4415 airfoil and the conventional equations above appear in Table 2.

TABLE 2
Chord Length and Setting Angle
Calculated Using Conventional Equations
and the 4415 Airfoil

| r (mm) | r/R | Setting Angle (°) | Chord (mm) |
|---|---|---|---|
| 280 | 0.1 | 29.2010563 | 317.0742 |
| 420 | 0.15 | 21.52965714 | 294.2421 |
| 560 | 0.2 | 16.25028066 | 260.4648 |
| 700 | 0.25 | 12.5264704 | 229.9553 |
| 840 | 0.3 | 9.806604877 | 204.5938 |
| 980 | 0.35 | 7.752104937 | 184.3323 |
| 1120 | 0.4 | 6.153961431 | 168.2439 |
| 1260 | 0.45 | 4.879453487 | 155.3051 |
| 1400 | 0.5 | 3.841460339 | 144.7347 |
| 1540 | 0.55 | 2.980921438 | 136.0935 |
| 1680 | 0.6 | 2.256602624 | 128.9193 |
| 1820 | 0.65 | 1.638948778 | 123.2576 |
| 1960 | 0.7 | 1.10627671 | 119.2188 |
| 2100 | 0.75 | 0.642347171 | 115.9989 |
| 2240 | 0.8 | 0.234773675 | 112.1442 |
| 2380 | 0.85 | −0.126046527 | 108.2302 |
| 2520 | 0.9 | −0.447667088 | 104.8421 |
| 2660 | 0.95 | −0.736107849 | 103.6087 |
| 2800 | 1 | −0.996223046 | 102.8339 |

The present invention includes portions of the wind turbine blade 10 with attributes that are modified from those calculated using conventional equations, for example, the equations used above. More specifically, at least one cross section of the blade taken perpendicular to the span 130 of the blade in each portion of the blade below may have the attributes described for that portion of the blade. Optionally, a majority of the cross sections of the blade in the each portion of the blade taken perpendicular to the span 130 may have the attributes described for that portion of the blade. Turning to FIG. 3, various locations along the span 130 of the blade are labeled in terms of percentage of the span 130 starting from the attachment section 100. The modifications to the conventional equations provide a general description of one embodiment of the current wind turbine blade design and will be described in reference to these points along the span of the blade.

In the section of the blade between approximately 0% and approximately 30% to 50% of the span of the blade, and optionally between approximately 10% and approximately 40% of the span of the blade (between approximately reference numerals 52 and 58), the blade setting angle 34 may be greater than the blade setting angle calculated using conventional equations by a factor of approximately 1.3. In the section of the blade between approximately 30% to 50% and approximately 40% to 60% of the span of the blade, and optionally between approximately 40% and approximately 50% of the span of the blade (between approximately reference numerals 58 and 60), the blade setting angle 34 may transition smoothly from a blade setting angle 34 equal to approximately 1.3 times that calculated with conventional equations to a blade setting angle 34 approximately equal to that calculated with conventional equations. In the section of the blade between approximately 40% to 60% and approximately 90% to 100%, and optionally between approximately 50% and approximately 95% of the span of the blade (between approximately reference numerals 60 and 64), the blade setting angle 34 may be approximately equal to the blade setting angle 34 calculated using conventional equations.

Referring to FIG. 3, in the section of the blade between approximately 0% to 20% and approximately 30% to 40% of the span of the blade, and optionally between approximately 10% and approximately 35% of the span of the blade (between approximately reference numerals 52 and 56), the chord length 22 may be greater than the chord length calculated using conventional equations by a factor of approximately 1.3. In the section of the blade between approximately 30% to 40% and approximately 60% to 70% of the span of the blade, and optionally between approximately 35% and approximately 65% of the span of the blade (between approximately reference numerals 56 and 62), the chord length 22 of the present blade may transition smoothly from approximately 1.3 times that calculated with conventional equations to approximately the chord length calculated with conventional equations. In the section of the blade between approximately 60% to 70% and approximately 90% to 100% of the span of the blade, and optionally between approximately 65% and approximately 95% of the span of the blade (between approximately reference numerals 62 and 64), the chord length 22 of the present invention may be approximately equal to the chord length calculated using conventional equations.

The above modifications to the blade setting angle 34 and the chord length 22 may provide an increase in the coefficient of lift and the overall lift force of the root section 70 of the blade 10 of the present invention. In any of the described sections of the blade, at least one cross section of the blade may have the noted characteristics. Optionally, a majority of the cross sections of the blade in the particular section of the blade may have the noted characteristics.

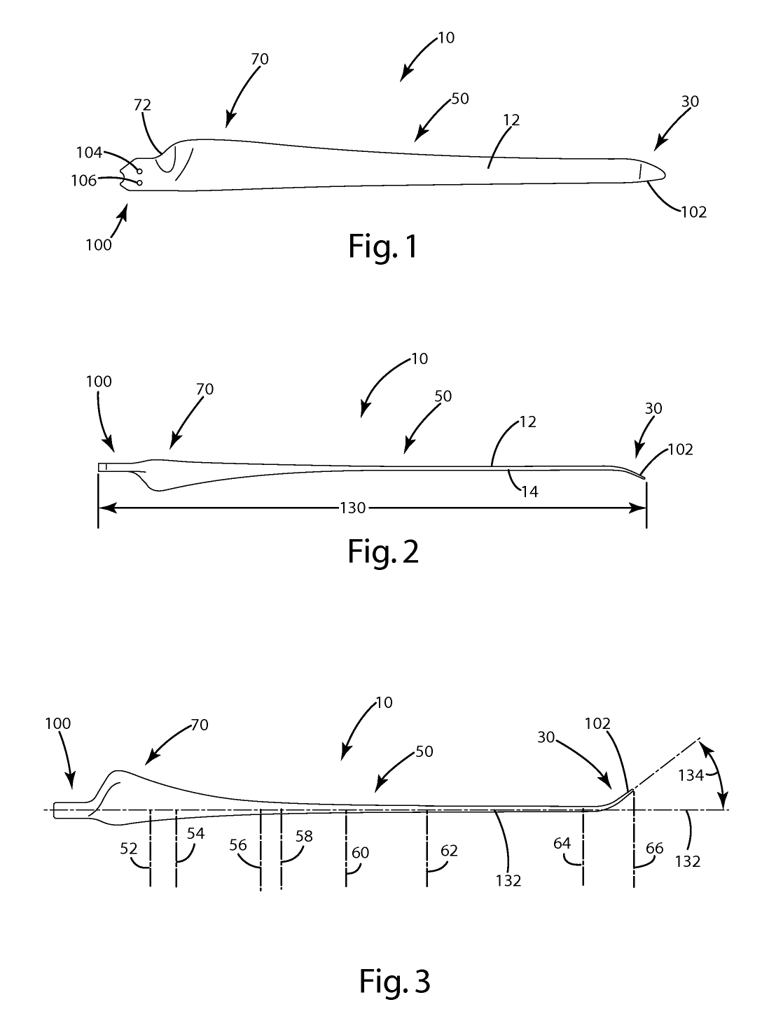

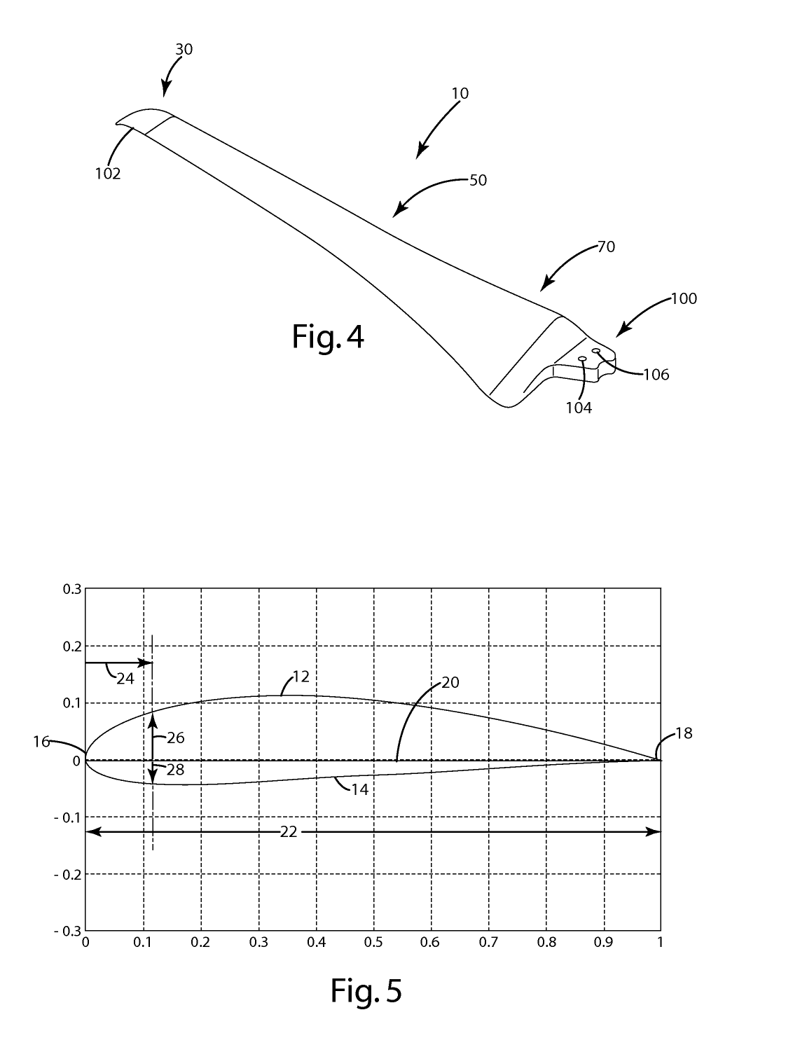

The tip section 30 of the blade 100, which may be between approximately 95% and approximately 100% of the span of the blade (from approximately reference numeral 64 to the end of the blade 66), may include a winglet structure 102 as seen in FIGS. 1-4. As shown in FIG. 3, the tip section 30 rises out of the plane of rotation 132 of the blade in the aft direction (toward the rear of the wind turbine) to form the winglet structure 102. The tip section 30 may make an angle 134 with the middle section 50 of the blade or with the plane of rotation 132. In one embodiment of the current invention, shown in FIG. 3, the angle 134 may be approximately equal to 35°. Optionally, the angle 134 may range between approximately 20° and 50° or between approximately 30° and 40° and may further vary depending on the wind characteristics of the region in which the wind turbine is installed. For instance, a blade tip design for a region that experiences consistent 30 mph winds may vary from a blade tip design for a region that experiences only 10 mph winds. The winglet structure 102 may increase the efficiency and decrease the noise during wind turbine operation.

Adjacent to the attachment section 100, the root section 70 includes a contour 72 that is designed to transition smoothly from the blade 10 to the hub 150 of the wind turbine. The attachment section 100 of the embodiment shown in FIG. 1 defines two threaded bores 104, 106 for receiving two fasteners (not pictured). Alternatively, any fastening means suitable to the application may be used to attach the blade 10 to the hub 150.

In alternative embodiments, the locations of the different sections of the blade may vary. The location along the span of the blade having increased chord length and/or increased blade setting angle may be between approximately 0% and approximately 20% to 50% of the span of the blade, and optionally between approximately 0% and approximately 30% to 40% of the span of the blade. The location of the transition section along the span of the blade may be between approximately 20% to 50% and approximately 30% to 60% of the span of the blade, and optionally between approximately 30% to 40% and approximately 40% to 50% of the span of the blade. The location of the conventional section along the span of the blade may be between approximately 30% to 60% and approximately 85% to 100% of the span of the blade, and optionally between approximately 40% to 50% and approximately 95% of the span of the blade. The alternative embodiments may include a winglet 102.

FIGS. 9-11 include graphs of the blade setting angle 34, chord length 22, and attack angle 32 of embodiments of the current invention. In FIGS. 9 and 11, design 1 represents a design with an enlarged blade setting angle 34 between 0% and 30% of the span of the blade 130, a transition section between 30% and 40% of the span of the blade 130, and a conventional blade setting angle 34 between 40% of the span of the blade 130 and the tip of the blade 66. Design 2 represents a design with an enlarged blade setting angle 34 between 0% and 40% of the span of the blade 130, a transition section between 40% and 50% of the span of the blade 130, and a conventional blade setting angle 34 between 50% of the span of the blade 130 and the tip of the blade 66.

The wind turbine blade 10 of the present invention has been described generally and one embodiment of the current invention will now be described particularly using data tables. Table 3 includes the blade setting angle 34 and chord length 22 data calculated according to one embodiment of the present wind turbine blade design 10. A calculation for a ¼ chord is also included in Table 3.

TABLE 3
One Embodiment With Increased Blade Setting Angle & Chord Length

| r (mm) | r/R | Setting Angle (°) | Chord (mm) | ¼ Chord |
|---|---|---|---|---|
| 280 | 0.1 | 37.96137319 | 412.1964174 | 103.0491044 |
| 420 | 0.15 | 27.98855428 | 382.5147123 | 95.62867808 |
| 560 | 0.2 | 21.12536485 | 338.6042817 | 84.65107042 |
| 700 | 0.25 | 16.28441151 | 298.9419456 | 74.73548641 |
| 840 | 0.3 | 12.74858634 | 265.971948 | 66.49298699 |
| 980 | 0.35 | 10.07773642 | 239.631933 | 59.90798325 |
| 1120 | 0.4 | 8.00014986 | 210.3049006 | 52.57622516 |
| 1260 | 0.45 | 5.61137151 | 186.3661765 | 46.59154412 |
| 1400 | 0.5 | 3.841460339 | 166.4449228 | 41.61123071 |
| 1540 | 0.55 | 2.980921438 | 149.7028991 | 37.42572478 |
| 1680 | 0.6 | 2.256602624 | 135.3652742 | 33.84131855 |
| 1820 | 0.65 | 1.638948778 | 123.2575878 | 30.81439695 |
| 1960 | 0.7 | 1.10627671 | 119.218831 | 29.80470776 |
| 2100 | 0.75 | 0.642347171 | 115.9989074 | 28.99972686 |
| 2240 | 0.8 | 0.234773675 | 112.1441977 | 28.03604942 |
| 2380 | 0.85 | −0.126046527 | 108.230203 | 27.05755074 |
| 2520 | 0.9 | −0.447667088 | 104.842137 | 26.21053426 |
| 2660 | 0.95 | −0.736107849 | 103.6087354 | 25.90218385 |
| 2800 | 1 | −0.996223046 | 102.8339186 | 25.70847965 |

Tables 4 through 22 include design data for an embodiment of the wind turbine blade 10 of the present invention. Each table corresponds to a cross section of the blade 10. The cross sections are taken perpendicular to the span 130 of the blade and are located sequentially from the root section 70 outward to the tip section 30. In this manner, Table 4 contains data for a cross section taken in the root section 70 of the blade 10 and Table 22 contains data for a cross-section taken in the tip section 30 of the blade 10. The following tables include the variable distance 24 from the leading edge 16 along the chord line 20 (labeled X), the corresponding distance 26 between the chord line 20 and the top surface 12 at the variable distance 24 (labeled Y1), and the corresponding distance 28 between the chord line 20 and the bottom surface 14 at the variable distance 24 (labeled Y2).

TABLE 4
Section 1

| X | Y1 | Y2 |
|---|---|---|
| 412.1964174 | 0 | 0 |
| 411.7553673 | 0.160756603 | −0.045341606 |
| 410.4322168 | 0.643026411 | −0.173122495 |
| 408.2352098 | 1.438565497 | −0.379220704 |
| 405.1725905 | 2.514398146 | −0.643026411 |
| 401.2608465 | 3.84167061 | −0.935685868 |
| 396.5082218 | 5.370919319 | −1.22422336 |
| 390.9435701 | 7.073290523 | −1.500394959 |
| 384.5833794 | 8.928174401 | −1.776566559 |
| 377.4606253 | 10.93144899 | −2.069226015 |
| 369.6082836 | 13.0707484 | −2.403105114 |
| 361.0510859 | 15.32134084 | −2.778203853 |
| 351.8302521 | 17.65437256 | −3.194522235 |
| 341.9870016 | 20.04511178 | −3.652060258 |
| 331.5625542 | 22.47707064 | −4.146695959 |
| 320.6022515 | 24.92963933 | −4.682551302 |
| 309.1473131 | 27.37808605 | −5.26374825 |
| 297.2513245 | 29.78943509 | −5.894408769 |
| 284.9678712 | 32.13071074 | −6.578654822 |
| 272.3464169 | 34.38130318 | −7.304120517 |
| 259.4405471 | 36.51235866 | −8.070805853 |
| 246.3079692 | 38.50326735 | −8.85810101 |
| 232.9981469 | 40.33341944 | −9.645396168 |
| 219.5770316 | 41.98220511 | −10.4244474 |
| 206.0982087 | 43.43725847 | −11.1828888 |
| 192.6193859 | 44.66972576 | −11.91659843 |
| 179.1982705 | 45.65487519 | −12.62557627 |
| 165.8884482 | 46.36385303 | −13.30982232 |
| 152.7558703 | 46.76368356 | −13.97345855 |
| 139.8500005 | 46.82963498 | −14.62060693 |
| 127.2285462 | 46.55346338 | −15.25126744 |
| 114.945093 | 45.92280286 | −15.84895225 |
| 103.0491044 | 44.94177539 | −16.38068563 |
| 91.59416591 | 43.62686882 | −16.8093699 |
| 80.63386318 | 42.00281494 | −17.09378543 |
| 70.20941578 | 40.09022356 | −17.21744436 |
| 60.36616533 | 37.90146058 | −17.17210275 |
| 51.14533147 | 35.47774565 | −16.9247849 |
| 42.58813385 | 32.85205447 | −16.45075902 |
| 34.7357921 | 30.02026508 | −15.73353725 |
| 27.613038 | 26.96176766 | −14.76487567 |
| 21.25284728 | 23.71365989 | −13.52416446 |
| 15.68819565 | 20.35013713 | −12.01552557 |
| 10.93557095 | 16.97424847 | −10.31315436 |
| 7.023826953 | 13.61484767 | −8.495368163 |
| 3.961207571 | 10.25956883 | −6.553923037 |
| 1.764200667 | 6.817728744 | −4.54240452 |
| 0.441050167 | 3.400620444 | −2.333031723 |
| 0 | 0.309147313 | 0.309147313 |

TABLE 5
Section 2

| X | Y1 | Y2 |
|---|---|---|
| 382.5147123 | 0 | 0 |
| 382.1054216 | 0.149180738 | −0.042076618 |
| 380.8775494 | 0.596722951 | −0.160656179 |
| 378.8387459 | 1.334976346 | −0.351913535 |
| 375.9966616 | 2.333339745 | −0.596722951 |
| 372.366597 | 3.565037119 | −0.868308397 |
| 367.9562024 | 4.984166702 | −1.136068696 |
| 362.7922538 | 6.563952464 | −1.392353553 |
| 356.8900518 | 8.285268669 | −1.64863841 |
| 350.2801975 | 10.14429017 | −1.920223856 |
| 342.9932923 | 12.12954153 | −2.230060773 |
| 335.0522868 | 14.21807186 | −2.578149161 |
| 326.4954327 | 16.38310513 | −2.964489021 |
| 317.3609814 | 18.60169046 | −3.389080351 |
| 307.6871843 | 20.85852726 | −3.848098006 |
| 297.5161181 | 23.1344898 | −4.345367132 |
| 286.8860342 | 25.40662719 | −4.884712876 |
| 275.8466597 | 27.64433826 | −5.469960386 |
| 264.4477212 | 29.81702183 | −6.104934809 |
| 252.7351207 | 31.90555216 | −6.778160703 |
| 240.7585851 | 33.88315322 | −7.489638067 |
| 228.5716664 | 35.73069928 | −8.220241168 |
| 216.2202663 | 37.4290646 | −8.950844269 |
| 203.7655873 | 38.95912345 | −9.673797075 |
| 191.2573562 | 40.30940039 | −10.37762415 |
| 178.7491251 | 41.45311938 | −11.05850033 |
| 166.294446 | 42.36732954 | −11.71642564 |
| 153.943046 | 43.02525484 | −12.35140006 |
| 141.7561272 | 43.39629411 | −12.96724875 |
| 129.7795916 | 43.45749647 | −13.56779685 |
| 118.0669911 | 43.20121161 | −14.15304436 |
| 106.6680527 | 42.6159641 | −14.70769069 |
| 95.62867808 | 41.70557909 | −15.20113467 |
| 84.99859423 | 40.48535715 | −15.59894997 |
| 74.82752803 | 38.97824919 | −15.86288512 |
| 65.15373095 | 37.20338092 | −15.97763953 |
| 56.01927962 | 35.1722278 | −15.93556292 |
| 47.46242551 | 32.92304129 | −15.70605409 |
| 39.52142008 | 30.48642257 | −15.26616217 |
| 32.23451481 | 27.8585465 | −14.60058657 |
| 25.62466058 | 25.02028733 | −13.701677 |
| 19.72245857 | 22.0060714 | −12.55030771 |
| 14.55850995 | 18.88475135 | −11.15030386 |
| 10.14811532 | 15.75195585 | −9.570518103 |
| 6.518050698 | 12.63446095 | −7.883628221 |
| 3.675966386 | 9.52079119 | −6.081983926 |
| 1.637162969 | 6.326793342 | −4.21531213 |
| 0.409290742 | 3.155746377 | −2.165033272 |
| 0 | 0.286886034 | 0.286886034 |

TABLE 6
Section 3

| X | Y1 | Y2 |
|---|---|---|
| 338.6042817 | 0 | 0 |
| 338.2419751 | 0.13205567 | −0.037246471 |
| 337.1550553 | 0.528222679 | −0.142213798 |
| 335.3502945 | 1.181728943 | −0.311515939 |
| 332.8344647 | 2.065486118 | −0.528222679 |
| 329.6211101 | 3.155791905 | −0.768631719 |
| 325.7170027 | 4.41201379 | −1.005654717 |
| 321.1458449 | 5.810449473 | −1.232519585 |
| 315.9211808 | 7.334168741 | −1.459384454 |
| 310.0700988 | 8.97978555 | −1.699793494 |
| 303.6196873 | 10.73714177 | −1.974062962 |
| 296.5902624 | 12.58592115 | −2.282192858 |
| 289.0156846 | 14.50242138 | −2.624183183 |
| 280.9298144 | 16.46632622 | −3.000033936 |
| 272.3665121 | 18.46409148 | −3.406359074 |
| 263.3630242 | 20.47878695 | −3.84654464 |
| 253.9532112 | 22.49009639 | −4.323976677 |
| 244.1810917 | 24.47093144 | −4.842041228 |
| 234.0906841 | 26.39420376 | −5.404124335 |
| 223.722621 | 28.24298313 | −6.000067871 |
| 213.1209209 | 29.99356727 | −6.629871835 |
| 202.3329885 | 31.62902595 | −7.276606013 |
| 191.3994563 | 33.13242896 | −7.923340191 |
| 180.3745008 | 34.48684609 | −8.563302283 |
| 169.3021408 | 35.6821192 | −9.186334161 |
| 158.2297808 | 36.694546 | −9.789049783 |
| 147.2048254 | 37.50381024 | −10.37144915 |
| 136.2712932 | 38.0862096 | −10.93353225 |
| 125.4833607 | 38.41465575 | −11.47868515 |
| 114.8816607 | 38.46883244 | −12.01029387 |
| 104.5135976 | 38.24196757 | −12.52835842 |
| 94.42318998 | 37.72390302 | −13.01933463 |
| 84.65107042 | 36.91802483 | −13.45613415 |
| 75.24125743 | 35.83787717 | −13.80828261 |
| 66.23776958 | 34.5037763 | −14.04191956 |
| 57.6744673 | 32.93265243 | −14.14350085 |
| 49.58859705 | 31.1346637 | −14.10625437 |
| 42.01401927 | 29.14367052 | −13.90309181 |
| 34.98459438 | 26.98676125 | −13.51369688 |
| 28.53418282 | 24.66054983 | −12.92452543 |
| 22.68310083 | 22.14810606 | −12.12880537 |
| 17.45843676 | 19.47990432 | −11.10960648 |
| 12.88727896 | 16.71689339 | −9.87031481 |
| 8.983171592 | 13.94372432 | −8.471879127 |
| 5.76981696 | 11.18409942 | −6.978634245 |
| 3.253987147 | 8.427860571 | −5.383808078 |
| 1.449226326 | 5.600514819 | −3.731419184 |
| 0.362306581 | 2.793485324 | −1.916500234 |
| 0 | 0.253953211 | 0.253953211 |

TABLE 7
Section 4

| X | Y1 | Y2 |
|---|---|---|
| 298.9419456 | 0 | 0 |
| 298.6220777 | 0.116587359 | −0.032883614 |
| 297.6624741 | 0.466349435 | −0.125555617 |
| 296.0691135 | 1.04330739 | −0.27502659 |
| 293.8479749 | 1.823545868 | −0.466349435 |
| 291.0110158 | 2.786138933 | −0.678598217 |
| 287.5642152 | 3.895213552 | −0.887857579 |
| 283.5284989 | 5.129843787 | −1.088148682 |
| 278.9158247 | 6.475082542 | −1.288439786 |
| 273.7501079 | 7.927940398 | −1.500688567 |
| 268.0552638 | 9.479449096 | −1.742831543 |
| 261.849229 | 11.11167212 | −2.014868714 |
| 255.1618977 | 12.80368353 | −2.316800079 |
| 248.023164 | 14.53754682 | −2.648625638 |
| 240.4629222 | 16.30130429 | −3.007355973 |
| 232.5140559 | 18.08000887 | −3.395980502 |
| 224.2064592 | 19.85572403 | −3.817488646 |
| 215.5789947 | 21.60453441 | −4.274869822 |
| 206.6705247 | 23.30252466 | −4.771113452 |
| 197.5169223 | 24.93474768 | −5.297251276 |
| 188.15705 | 26.48027754 | −5.853283295 |
| 178.6327596 | 27.92416714 | −6.424262411 |
| 168.9799242 | 29.25146938 | −6.995241528 |
| 159.2463744 | 30.44723716 | −7.560241805 |
| 149.4709728 | 31.50250223 | −8.110294985 |
| 139.6955712 | 32.39633865 | −8.642411648 |
| 129.9620214 | 33.1108099 | −9.156591795 |
| 120.309186 | 33.62499004 | −9.652835424 |
| 110.7848956 | 33.91496373 | −10.13413196 |
| 101.4250233 | 33.96279444 | −10.60347081 |
| 92.27142094 | 33.76250334 | −11.06085199 |
| 83.36295096 | 33.30512216 | −11.49431781 |
| 74.73548641 | 32.59364033 | −11.87995292 |
| 66.42788974 | 31.64001553 | −12.19085254 |
| 58.4790234 | 30.46218426 | −12.39712249 |
| 50.9187816 | 29.07509363 | −12.48680507 |
| 43.78004794 | 27.4877119 | −12.45392145 |
| 37.09271661 | 25.72993326 | −12.27455629 |
| 30.88668182 | 23.82567307 | −11.93077305 |
| 25.19183776 | 21.7719419 | −11.41061406 |
| 20.02612094 | 19.55379266 | −10.70810049 |
| 15.41344672 | 17.19813013 | −9.808285236 |
| 11.37773045 | 14.75876386 | −8.714157715 |
| 7.930929817 | 12.31042932 | −7.47952748 |
| 5.093970753 | 9.874052464 | −6.161193499 |
| 2.872832097 | 7.440665027 | −4.753176935 |
| 1.279471527 | 4.944499781 | −3.294340241 |
| 0.319867882 | 2.466271051 | −1.692011412 |
| 0 | 0.224206459 | 0.224206459 |

TABLE 8
Section 5

| X | Y1 | Y2 |
|---|---|---|
| 265.971948 | 0 | 0 |
| 265.687358 | 0.10372906 | −0.029256914 |
| 264.833588 | 0.414916239 | −0.111708218 |
| 263.4159575 | 0.928242098 | −0.244694192 |
| 261.439786 | 1.622428883 | −0.414916239 |
| 258.9157122 | 2.478858555 | −0.603756322 |
| 255.8490556 | 3.465614482 | −0.789936685 |
| 252.2584343 | 4.564078627 | −0.968137891 |
| 248.1544872 | 5.760952393 | −1.146339096 |
| 243.5584919 | 7.05357606 | −1.335179179 |
| 238.4917263 | 8.43397047 | −1.550616457 |
| 232.9701487 | 9.886177306 | −1.792650929 |
| 227.0203562 | 11.39157853 | −2.061282597 |
| 220.6689461 | 12.93421583 | −2.356511459 |
| 213.9425155 | 14.50345032 | −2.675677796 |
| 206.8703214 | 16.08598341 | −3.021441329 |
| 199.478961 | 17.66585678 | −3.396461775 |
| 191.8030106 | 19.22179268 | −3.803398856 |
| 183.8770465 | 20.73251334 | −4.244912289 |
| 175.7329855 | 22.18472018 | −4.713022918 |
| 167.4054038 | 23.55979515 | −5.207730741 |
| 158.9315375 | 24.84443966 | −5.715737162 |
| 150.3433033 | 26.02535511 | −6.223743582 |
| 141.6832567 | 27.0892429 | −6.726430564 |
| 132.985974 | 28.02812388 | −7.215818948 |
| 124.2886913 | 28.82338 | −7.689249016 |
| 115.6286447 | 29.45905296 | −8.146720766 |
| 107.0404105 | 29.91652471 | −8.5882342 |
| 98.56654419 | 30.1745175 | −9.016449036 |
| 90.2389625 | 30.21707301 | −9.434024994 |
| 82.09490146 | 30.0388718 | −9.840962074 |
| 74.16893741 | 29.63193472 | −10.2266214 |
| 66.49298699 | 28.99892149 | −10.56972521 |
| 59.10162656 | 28.15047097 | −10.84633604 |
| 52.02943246 | 27.1025415 | −11.02985668 |
| 45.3030019 | 25.86843166 | −11.10964827 |
| 38.95159178 | 24.45612061 | −11.08039135 |
| 33.0017993 | 22.89220556 | −10.92080818 |
| 27.48022166 | 21.19796425 | −10.61494044 |
| 22.41345605 | 19.37073697 | −10.15214925 |
| 17.81746079 | 17.39722512 | −9.527115176 |
| 13.71351364 | 15.30136617 | −8.726539613 |
| 10.12289234 | 13.13103507 | −7.753082283 |
| 7.056235779 | 10.95272482 | −6.654618138 |
| 4.532161993 | 8.785053441 | −5.481681847 |
| 2.55599042 | 6.620041785 | −4.228953973 |
| 1.138359937 | 4.399176019 | −2.931010867 |
| 0.284589984 | 2.194268571 | −1.505401225 |
| 0 | 0.199478961 | 0.199478961 |

TABLE 9
Section 6

| X | Y1 | Y2 |
|---|---|---|
| 239.631933 | 0 | 0 |
| 239.3755268 | 0.093456454 | −0.026359513 |
| 238.6063083 | 0.373825816 | −0.100645412 |
| 237.3290701 | 0.836315446 | −0.220461378 |
| 235.5486049 | 1.461754791 | −0.373825816 |
| 233.2744978 | 2.233369616 | −0.543964488 |
| 230.5115416 | 3.122404087 | −0.711706841 |
| 227.2765105 | 4.112083971 | −0.872260236 |
| 223.5789898 | 5.190427669 | −1.032813631 |
| 219.43815 | 6.355038864 | −1.202952304 |
| 214.8731617 | 7.598728596 | −1.397054169 |
| 209.8984028 | 8.90711895 | −1.615119229 |
| 204.5378364 | 10.26343569 | −1.857147481 |
| 198.8154259 | 11.6533009 | −2.123138927 |
| 192.7551343 | 13.06712931 | −2.410697246 |
| 186.3833212 | 14.49293931 | −2.722218759 |
| 179.7239498 | 15.91635299 | −3.060099785 |
| 172.8081722 | 17.3181998 | −3.426736642 |
| 165.6671406 | 18.67930918 | −3.824525651 |
| 158.3296108 | 19.98769953 | −4.246277853 |
| 150.826735 | 21.22659663 | −4.691993248 |
| 143.1920616 | 22.38401886 | −5.14969024 |
| 135.4543465 | 23.44798465 | −5.607387233 |
| 127.6519307 | 24.40651238 | −6.060291586 |
| 119.8159665 | 25.2524131 | −6.501214343 |
| 111.9800023 | 25.96891258 | −6.927759183 |
| 104.1775866 | 26.5416329 | −7.339926108 |
| 96.43987144 | 26.95379983 | −7.737715117 |
| 88.80519806 | 27.1862428 | −8.123522529 |
| 81.30232223 | 27.22458391 | −8.499744664 |
| 73.96479244 | 27.06403051 | −8.866381522 |
| 66.82376084 | 26.69739366 | −9.213847824 |
| 59.90798325 | 26.12706966 | −9.522973018 |
| 53.24861183 | 25.36264379 | −9.772190228 |
| 46.87679874 | 24.41849397 | −9.937536262 |
| 40.81650715 | 23.3066018 | −10.00942584 |
| 35.09409659 | 22.03415624 | −9.983066329 |
| 29.73353025 | 20.62512047 | −9.83928717 |
| 24.75877132 | 19.09866506 | −9.563710447 |
| 20.193783 | 17.45239368 | −9.146750883 |
| 16.05294319 | 15.67432474 | −8.583615841 |
| 12.35542247 | 13.78602511 | −7.862323722 |
| 9.12039137 | 11.83062853 | −6.985270847 |
| 6.357435183 | 9.868043002 | −5.995590964 |
| 4.083328139 | 7.915042747 | −4.938814139 |
| 2.302862876 | 5.964438813 | −3.810147735 |
| 1.025624673 | 3.963512172 | −2.640743902 |
| 0.256406168 | 1.976963447 | −1.356316741 |
| 0 | 0.17972395 | 0.17972395 |

TABLE 10
Section 7

| X | Y1 | Y2 |
|---|---|---|
| 210.3049006 | 0 | 0 |
| 210.0798744 | 0.082018911 | −0.023133539 |
| 209.4047957 | 0.328075645 | −0.088328058 |
| 208.2838705 | 0.733964103 | −0.193480509 |
| 206.7213051 | 1.282859894 | −0.328075645 |
| 204.7255116 | 1.960041674 | −0.477392124 |
| 202.3006961 | 2.740272855 | −0.624605555 |
| 199.46158 | 3.608832095 | −0.765509838 |
| 196.2165753 | 4.555204148 | −0.906414122 |
| 192.5825067 | 5.577285965 | −1.055730601 |
| 188.5761983 | 6.668768399 | −1.226077571 |
| 184.2102686 | 7.817033157 | −1.41745503 |
| 179.5057479 | 9.007358894 | −1.62986298 |
| 174.4836669 | 10.22712732 | −1.86330142 |
| 169.165056 | 11.46792623 | −2.1156673 |
| 163.5730487 | 12.71924039 | −2.389063671 |
| 157.7286755 | 13.9684515 | −2.685593581 |
| 151.659276 | 15.19873517 | −3.007360079 |
| 145.39219 | 16.393267 | −3.356466214 |
| 138.9526539 | 17.54153176 | −3.726602839 |
| 132.3680075 | 18.6288081 | −4.117769954 |
| 125.6676934 | 19.64458077 | −4.519452315 |
| 118.8769481 | 20.57833453 | −4.921134675 |
| 112.0294206 | 21.41955413 | −5.318610937 |
| 105.1524503 | 22.16193043 | −5.705571954 |
| 98.27548007 | 22.79074208 | −6.079914677 |
| 91.4279525 | 23.29337079 | −6.441639106 |
| 84.63720726 | 23.65509522 | −6.790745241 |
| 77.93689313 | 23.85909098 | −7.129336131 |
| 71.35224669 | 23.89273976 | −7.459514825 |
| 64.91271063 | 23.75183548 | −7.781281323 |
| 58.64562459 | 23.43006898 | −8.086223429 |
| 52.57622516 | 22.92954332 | −8.357516751 |
| 46.73185197 | 22.25867068 | −8.576233848 |
| 41.13984466 | 21.43006937 | −8.721344229 |
| 35.82123372 | 20.45425464 | −8.784435699 |
| 30.7991527 | 19.33753561 | −8.76130216 |
| 26.09463207 | 18.1009428 | −8.63511922 |
| 21.72870233 | 16.76130058 | −8.393268584 |
| 17.72239398 | 15.31650591 | −8.027338057 |
| 14.08832529 | 13.75604355 | −7.533121541 |
| 10.84332068 | 12.09884093 | −6.90010379 |
| 8.004204518 | 10.38275294 | −6.130387853 |
| 5.579389014 | 8.660355808 | −5.261828614 |
| 3.583595507 | 6.946370868 | −4.334384002 |
| 2.021030095 | 5.234488977 | −3.34384792 |
| 0.900104975 | 3.478443056 | −2.317560005 |
| 0.225026244 | 1.73501543 | −1.190325738 |
| 0 | 0.157728675 | 0.157728675 |

TABLE 11
Section 8

| X | Y1 | Y2 |
|---|---|---|
| 186.3661765 | 0 | 0 |
| 186.1667647 | 0.072682809 | −0.020500279 |
| 185.5685292 | 0.290731235 | −0.078273794 |
| 184.5751975 | 0.650417956 | −0.171456882 |
| 183.1904968 | 1.136833677 | −0.290731235 |
| 181.4218818 | 1.736932765 | −0.423051221 |
| 179.2730798 | 2.42835128 | −0.553507544 |
| 176.7571364 | 3.198043588 | −0.678372882 |
| 173.8815063 | 4.036691383 | −0.803238221 |
| 170.6610988 | 4.942431 | −0.935558206 |
| 167.1108231 | 5.909671456 | −1.086514809 |
| 163.2418613 | 6.92723078 | −1.256108029 |
| 159.0728499 | 7.982063339 | −1.444337868 |
| 154.6224256 | 9.062987162 | −1.651204324 |
| 149.909225 | 10.1625476 | −1.874843735 |
| 144.9537484 | 11.27142635 | −2.117119765 |
| 139.7746324 | 12.37844144 | −2.379896074 |
| 134.3961045 | 13.46868357 | −2.665036324 |
| 128.8423925 | 14.52724346 | −2.974404177 |
| 123.1358601 | 15.54480278 | −3.302408647 |
| 117.3007351 | 16.50831591 | −3.649049736 |
| 111.3631088 | 17.40846455 | −4.005009133 |
| 105.3453449 | 18.23593037 | −4.36096853 |
| 99.27726221 | 18.98139507 | −4.713200603 |
| 93.18308824 | 19.63926768 | −5.056114368 |
| 87.08891427 | 20.19650255 | −5.387846162 |
| 81.02083156 | 20.64191771 | −5.708395986 |
| 75.00306773 | 20.96246753 | −6.017763839 |
| 69.06544134 | 21.14324272 | −6.317813383 |
| 63.23031636 | 21.17306131 | −6.61040828 |
| 57.52378403 | 21.04819597 | −6.89554853 |
| 51.97007197 | 20.76305572 | −7.165779486 |
| 46.59154412 | 20.31950422 | −7.406191853 |
| 41.41242808 | 19.72499612 | −7.600012677 |
| 36.45695144 | 18.99071338 | −7.728605339 |
| 31.74375084 | 18.12597432 | −7.784515192 |
| 27.29332655 | 17.13636993 | −7.764014912 |
| 23.12431518 | 16.04053681 | −7.652195206 |
| 19.25535335 | 14.85338427 | −7.437874103 |
| 15.70507769 | 13.57304863 | −7.113596956 |
| 12.48467016 | 12.1902116 | −6.675636442 |
| 9.609040059 | 10.72164613 | −6.11467425 |
| 7.093096677 | 9.200898133 | −5.432574044 |
| 4.944294662 | 7.674559148 | −4.662881736 |
| 3.175679647 | 6.155674809 | −3.841006897 |
| 1.790978956 | 4.638654133 | −2.963222206 |
| 0.797647235 | 3.082496559 | −2.053755265 |
| 0.199411809 | 1.537520956 | −1.054832559 |
| 0 | 0.139774632 | 0.139774632 |

TABLE 12
Section 9

| X | Y1 | Y2 |
|---|---|---|
| 166.4449228 | 0 | 0 |
| 166.2668268 | 0.06491352 | −0.018308942 |
| 165.7325386 | 0.25965408 | −0.069906868 |
| 164.8453871 | 0.580892781 | −0.153129329 |
| 163.6087014 | 1.015314029 | −0.25965408 |
| 162.029139 | 1.551266681 | −0.377829975 |
| 160.1100291 | 2.168777345 | −0.494341421 |
| 157.8630226 | 2.856194876 | −0.605859519 |
| 155.2947775 | 3.605197029 | −0.717377617 |
| 152.4186092 | 4.414119354 | −0.835553513 |
| 149.2478334 | 5.277968503 | −0.9703739 |
| 145.7924368 | 6.186757782 | −1.12183878 |
| 142.0690639 | 7.128836045 | −1.289948152 |
| 138.0943591 | 8.094216598 | −1.474702016 |
| 133.884967 | 9.076241643 | −1.674435924 |
| 129.4591965 | 10.06658893 | −1.890814324 |
| 124.8336921 | 11.05527178 | −2.125501665 |
| 120.0300917 | 12.02897457 | −2.380162397 |
| 115.070033 | 12.97438174 | −2.656460969 |
| 109.9734894 | 13.88317101 | −2.949404033 |
| 104.7620989 | 14.74369127 | −3.258991589 |
| 99.45916365 | 15.54762024 | −3.576901392 |
| 94.08465709 | 16.2866357 | −3.894811195 |
| 88.6652104 | 16.95241539 | −4.209392099 |
| 83.22246142 | 17.53996597 | −4.515650757 |
| 77.77971244 | 18.03763629 | −4.811922719 |
| 72.36026576 | 18.43543965 | −5.098207987 |
| 66.9857592 | 18.72172492 | −5.374506559 |
| 61.68282396 | 18.8831765 | −5.642482884 |
| 56.47143342 | 18.90980768 | −5.903801413 |
| 51.37488988 | 18.79828959 | −6.158462145 |
| 46.41483118 | 18.54362885 | −6.399807283 |
| 41.61123071 | 18.14748994 | −6.614521234 |
| 36.98572631 | 17.61653063 | −6.787623954 |
| 32.55995581 | 16.96073764 | −6.90247095 |
| 28.35056371 | 16.1884332 | −6.952404427 |
| 24.37585895 | 15.30461066 | −6.934095486 |
| 20.65248603 | 14.32591451 | −6.834228532 |
| 17.19708943 | 13.26566035 | −6.642816871 |
| 14.02631365 | 12.12218373 | −6.353202705 |
| 11.15014538 | 10.8871624 | −5.962057136 |
| 8.581900222 | 9.575576411 | −5.461057918 |
| 6.334893763 | 8.217385841 | −4.851869501 |
| 4.415783803 | 6.854201923 | −4.16445197 |
| 2.836221485 | 5.497675802 | −3.43042986 |
| 1.599535709 | 4.14281413 | −2.646474273 |
| 0.71238427 | 2.752999024 | −1.83422305 |
| 0.178096067 | 1.373170613 | −0.942078263 |
| 0 | 0.124833692 | 0.124833692 |

TABLE 13
Section 10

| X | Y1 | Y2 |
|---|---|---|
| 149.7028991 | 0 | 0 |
| 149.542717 | 0.058384131 | −0.016467319 |
| 149.0621707 | 0.233536523 | −0.062875218 |
| 148.2642543 | 0.522463118 | −0.137726667 |
| 147.1519617 | 0.913187685 | −0.233536523 |
| 145.7312812 | 1.39523102 | −0.339825581 |
| 144.0052068 | 1.950628775 | −0.44461761 |
| 141.9842176 | 2.568901749 | −0.544918553 |
| 139.6743019 | 3.242564795 | −0.645219495 |
| 137.0874358 | 3.970120884 | −0.751508554 |
| 134.2355956 | 4.747078931 | −0.872767902 |
| 131.1277634 | 5.56445676 | −1.00899754 |
| 127.7789095 | 6.411775169 | −1.160197468 |
| 124.2040043 | 7.280051984 | −1.326367686 |
| 120.418018 | 8.163299089 | −1.506011165 |
| 116.4374179 | 9.054031338 | −1.700624934 |
| 112.2771743 | 9.943266559 | −1.911706022 |
| 107.9567487 | 10.81902852 | −2.140751457 |
| 103.4956023 | 11.66934099 | −2.38925827 |
| 98.9116995 | 12.48671881 | −2.652735372 |
| 94.22450173 | 13.2606828 | −2.931182765 |
| 89.45496736 | 13.98374781 | −3.217115302 |
| 84.62106075 | 14.64842868 | −3.503047839 |
| 79.74673436 | 15.24724027 | −3.785986319 |
| 74.85144956 | 15.77569151 | −4.061439653 |
| 69.95616475 | 16.22330318 | −4.327910813 |
| 65.08183836 | 16.58109311 | −4.5853998 |
| 60.24793175 | 16.83858209 | −4.833906612 |
| 55.47839738 | 16.9837939 | −5.07492828 |
| 50.79119961 | 17.00774637 | −5.309961831 |
| 46.20729684 | 16.90744543 | −5.539007267 |
| 41.74615045 | 16.67839999 | −5.756076471 |
| 37.42572478 | 16.32210709 | −5.949193211 |
| 33.26548121 | 15.84455484 | −6.104884226 |
| 29.28488112 | 15.25472542 | −6.208179226 |
| 25.49889481 | 14.56010397 | −6.253090096 |
| 21.92398957 | 13.76518157 | −6.236622777 |
| 18.57513572 | 12.88492853 | −6.146801038 |
| 15.46730354 | 11.93132106 | −5.974642704 |
| 12.61546331 | 10.90286214 | −5.714159659 |
| 10.02859721 | 9.792066631 | −5.362357846 |
| 7.718681478 | 8.612407786 | −4.91175212 |
| 5.69769234 | 7.390832129 | −4.363839509 |
| 3.971617913 | 6.164765385 | −3.745566536 |
| 2.550937401 | 4.944686758 | −3.085376751 |
| 1.43864486 | 3.726105159 | −2.380276096 |
| 0.640728408 | 2.476085951 | −1.649725948 |
| 0.160182102 | 1.235048918 | −0.847318409 |
| 0 | 0.112277174 | 0.112277174 |

TABLE 14
Section 11

| X | Y1 | Y2 |
|---|---|---|
| 135.3652742 | 0 | 0 |
| 135.2204333 | 0.052792457 | −0.01489018 |
| 134.7859108 | 0.211169828 | −0.056853415 |
| 134.0644139 | 0.472424807 | −0.124536052 |
| 133.0586499 | 0.825728173 | −0.211169828 |
| 131.7740335 | 1.261604355 | −0.307279172 |
| 130.2132718 | 1.763809523 | −0.402034864 |
| 128.3858406 | 2.322868105 | −0.492729598 |
| 126.2971545 | 2.932011839 | −0.583424332 |
| 123.9580425 | 3.589887071 | −0.679533676 |
| 121.3793341 | 4.292432844 | −0.789179548 |
| 118.569151 | 5.031527241 | −0.912361948 |
| 115.5410298 | 5.797694693 | −1.049080875 |
| 112.308507 | 6.582813283 | −1.199336329 |
| 108.8851192 | 7.381468401 | −1.361774658 |
| 105.2857566 | 8.186891783 | −1.537749515 |
| 101.5239556 | 8.990961511 | −1.728614551 |
| 97.61731382 | 9.782848365 | −1.935723421 |
| 93.58342865 | 10.55172312 | −2.160429776 |
| 89.43854396 | 11.29081752 | −2.398672659 |
| 85.20025722 | 11.99065599 | −2.650452068 |
| 80.88751959 | 12.64447026 | −2.908999742 |
| 76.51657488 | 13.24549208 | −3.167547416 |
| 72.10908156 | 13.78695318 | −3.423387784 |
| 67.68263709 | 14.26479259 | −3.672459889 |
| 63.25619263 | 14.66953476 | −3.913410077 |
| 58.8486993 | 14.99305777 | −4.146238348 |
| 54.47775459 | 15.22588604 | −4.370944703 |
| 50.16501696 | 15.35719036 | −4.588882795 |
| 45.92673022 | 15.3788488 | −4.801406275 |
| 41.78184553 | 15.28815407 | −5.008515145 |
| 37.74796036 | 15.0810452 | −5.204794792 |
| 33.84131855 | 14.75887584 | −5.379415996 |
| 30.07951758 | 14.32706062 | −5.520195881 |
| 26.48015494 | 13.79372144 | −5.61359792 |
| 23.05676715 | 13.16562657 | −5.654207503 |
| 19.8242444 | 12.44683696 | −5.639317322 |
| 16.79612322 | 11.65088915 | −5.558098158 |
| 13.98594013 | 10.78861235 | −5.402428093 |
| 11.40723166 | 9.858652919 | −5.166892516 |
| 9.068119717 | 8.854242584 | −4.848784121 |
| 6.979433537 | 7.787564224 | −4.441334646 |
| 5.152002335 | 6.682983586 | −3.945897742 |
| 3.591240724 | 5.574341991 | −3.38683916 |
| 2.306624272 | 4.471115006 | −2.789878301 |
| 1.300860285 | 3.369241674 | −2.152307859 |
| 0.579363373 | 2.238941635 | −1.491725321 |
| 0.144840843 | 1.116763512 | −0.766167452 |
| 0 | 0.101523956 | 0.101523956 |

TABLE 15
Section 12

| X | Y1 | Y2 |
|---|---|---|
| 123.2575878 | 0 | 0 |
| 123.1257022 | 0.048070459 | −0.013558335 |
| 122.7300453 | 0.192281837 | −0.051768187 |
| 122.0730824 | 0.430168981 | −0.113396981 |
| 121.1572785 | 0.751871286 | −0.192281837 |
| 119.987564 | 1.148760718 | −0.279794724 |
| 118.566404 | 1.606046369 | −0.366075036 |
| 116.9024266 | 2.115100207 | −0.44865762 |
| 115.000562 | 2.669759352 | −0.531240203 |
| 112.8706709 | 3.268791229 | −0.618753091 |
| 110.5226138 | 3.908498109 | −0.718591737 |
| 107.9637863 | 4.581484539 | −0.830756142 |
| 105.2065141 | 5.279122486 | −0.955246306 |
| 102.2631229 | 5.994016495 | −1.092062228 |
| 99.14593848 | 6.721236263 | −1.239971333 |
| 95.86851922 | 7.454618911 | −1.400206197 |
| 92.44319086 | 8.186768982 | −1.573999396 |
| 88.88597687 | 8.907825871 | −1.762583506 |
| 85.21290076 | 9.60792897 | −1.967191101 |
| 81.43875342 | 10.2809154 | −2.184124456 |
| 77.57955834 | 10.91815713 | −2.413383569 |
| 73.65257159 | 11.51349128 | −2.648805562 |
| 69.67258408 | 12.06075497 | −2.884227555 |
| 65.65931703 | 12.55378532 | −3.117184396 |
| 61.6287939 | 12.9888846 | −3.343978357 |
| 57.59827078 | 13.35742479 | −3.563376864 |
| 53.58500372 | 13.65201043 | −3.775379915 |
| 49.60501621 | 13.86401348 | −3.97998751 |
| 45.67802947 | 13.98357334 | −4.178432227 |
| 41.81883439 | 14.00329455 | −4.37194664 |
| 38.04468705 | 13.92071197 | −4.560530749 |
| 34.37161094 | 13.73212786 | −4.739254251 |
| 30.81439695 | 13.4387748 | −4.898256539 |
| 27.38906859 | 13.04558309 | −5.026444431 |
| 24.11164933 | 12.5599482 | −5.111492166 |
| 20.99446493 | 11.98803299 | −5.148469443 |
| 18.05107373 | 11.3335352 | −5.134911108 |
| 15.2938015 | 10.60878058 | −5.060956555 |
| 12.73497397 | 9.823629748 | −4.919210329 |
| 10.38691692 | 8.97685012 | −4.704742127 |
| 8.257025807 | 8.062278819 | −4.415086795 |
| 6.355161227 | 7.091009027 | −4.044081456 |
| 4.691183792 | 6.08522711 | −3.592958685 |
| 3.270023805 | 5.075747466 | −3.083904847 |
| 2.100309296 | 4.071198125 | −2.540338885 |
| 1.184505419 | 3.067881361 | −1.959795646 |
| 0.527542476 | 2.038680502 | −1.358298618 |
| 0.131885619 | 1.016875099 | −0.697637947 |
| 0 | 0.092443191 | 0.092443191 |

TABLE 16
Section 13

| X | Y1 | Y2 |
|---|---|---|
| 119.218831 | 0 | 0 |
| 119.0912669 | 0.046495344 | −0.013114071 |
| 118.7085744 | 0.185981376 | −0.050071909 |
| 118.0731381 | 0.41607372 | −0.109681325 |
| 117.1873422 | 0.727234869 | −0.185981376 |
| 116.0559555 | 1.111119505 | −0.270626746 |
| 114.6813623 | 1.553421368 | −0.354079928 |
| 113.0719081 | 2.045795141 | −0.433956545 |
| 111.2323615 | 2.58227988 | −0.513833162 |
| 109.1722601 | 3.161683399 | −0.598478532 |
| 106.9011414 | 3.780429132 | −0.695045785 |
| 104.4261585 | 4.43136395 | −0.803534921 |
| 101.7592332 | 5.106142533 | −0.923945941 |
| 98.91228755 | 5.797611753 | −1.056278843 |
| 95.89724331 | 6.501002856 | −1.19934144 |
| 92.72721459 | 7.210354901 | −1.354325921 |
| 89.41412328 | 7.918514758 | −1.522424472 |
| 85.97346781 | 8.615944919 | −1.704829284 |
| 82.42074665 | 9.293107879 | −1.902732543 |
| 78.77026604 | 9.944042697 | −2.112557686 |
| 75.03752444 | 10.56040405 | −2.334304712 |
| 71.23921249 | 11.13623101 | −2.562012679 |
| 67.38963643 | 11.66556262 | −2.789720646 |
| 63.50787129 | 12.14243794 | −3.015044237 |
| 59.60941552 | 12.56328041 | −3.234406886 |
| 55.71095974 | 12.91974472 | −3.446616405 |
| 51.82919461 | 13.20467773 | −3.651672795 |
| 47.97961855 | 13.40973412 | −3.849576054 |
| 44.18130659 | 13.52537638 | −4.041518372 |
| 40.44856499 | 13.54445139 | −4.228691937 |
| 36.79808439 | 13.46457478 | −4.411096748 |
| 33.24536322 | 13.28216997 | −4.583964053 |
| 29.80470776 | 12.99842915 | −4.737756345 |
| 26.49161644 | 12.61812108 | −4.86174393 |
| 23.32158773 | 12.14839888 | −4.944004923 |
| 20.30654349 | 11.59522351 | −4.979770572 |
| 17.45959781 | 10.96217151 | −4.966656501 |
| 14.79267256 | 10.26116479 | −4.895125202 |
| 12.31768962 | 9.501740834 | −4.758023547 |
| 10.04657089 | 8.682707464 | −4.550582781 |
| 7.986469491 | 7.798103738 | −4.270418528 |
| 6.146922928 | 6.85865935 | −3.911569846 |
| 4.537468709 | 5.885833688 | −3.475228925 |
| 3.162875587 | 4.909431462 | −2.982855153 |
| 2.031488881 | 3.937797989 | −2.457100108 |
| 1.145692966 | 2.967356705 | −1.895579413 |
| 0.510256597 | 1.971879465 | −1.313791518 |
| 0.127564149 | 0.983555356 | −0.674778584 |
| 0 | 0.089414123 | 0.089414123 |

TABLE 17
Section 14

| X | Y1 | Y2 |
|---|---|---|
| 115.9989074 | 0 | 0 |
| 115.8747886 | 0.045239574 | −0.01275988 |
| 115.5024321 | 0.180958296 | −0.048719541 |
| 114.8841579 | 0.404836187 | −0.106718995 |
| 114.022286 | 0.707593335 | −0.180958296 |
| 112.9214564 | 1.081109817 | −0.26331752 |
| 111.583989 | 1.511465764 | −0.344516755 |
| 110.0180038 | 1.990541251 | −0.422236023 |
| 108.2281406 | 2.512536335 | −0.499955291 |
| 106.2236795 | 3.076291025 | −0.582314515 |
| 104.0139003 | 3.678325354 | −0.67627363 |
| 101.605763 | 4.311679389 | −0.781832636 |
| 99.01086743 | 4.968233205 | −0.898991533 |
| 96.24081352 | 5.641026868 | −1.02775032 |
| 93.30720116 | 6.325420422 | −1.166949009 |
| 90.22279021 | 7.015613921 | −1.317747588 |
| 86.99918057 | 7.704647431 | −1.481306048 |
| 83.6514521 | 8.38324104 | −1.658784376 |
| 80.19468466 | 9.042114834 | −1.851342563 |
| 76.64279811 | 9.675468868 | −2.05550064 |
| 73.01087232 | 10.27518322 | −2.271258607 |
| 69.31514713 | 10.83545794 | −2.492816521 |
| 65.56954241 | 11.35049309 | −2.714374434 |
| 61.79261799 | 11.81448872 | −2.933612369 |
| 57.99945371 | 12.22396486 | −3.147050358 |
| 54.20628944 | 12.5708016 | −3.353528414 |
| 50.42936501 | 12.84803899 | −3.553046534 |
| 46.68376029 | 13.04755711 | −3.745604721 |
| 42.9880351 | 13.16007605 | −3.932362962 |
| 39.35610931 | 13.17863587 | −4.114481246 |
| 35.80422277 | 13.1009166 | −4.291959575 |
| 32.34745532 | 12.92343828 | −4.460157991 |
| 28.99972686 | 12.64736088 | −4.609796581 |
| 25.77611722 | 12.27732436 | −4.730435445 |
| 22.69170627 | 11.82028867 | −4.810474691 |
| 19.7580939 | 11.28205374 | −4.845274363 |
| 16.98803999 | 10.66609954 | −4.832514483 |
| 14.39314443 | 9.984025962 | −4.762915139 |
| 11.98500712 | 9.245112922 | −4.629516395 |
| 9.775227929 | 8.448200428 | −4.427678296 |
| 7.770766808 | 7.587488535 | −4.155080864 |
| 5.980903667 | 6.673417144 | −3.805924153 |
| 4.414918417 | 5.72686606 | −3.381368151 |
| 3.077451014 | 4.776835008 | −2.902292664 |
| 1.976621383 | 3.831443912 | −2.390737482 |
| 1.1147495 | 2.887212806 | −1.844382628 |
| 0.496475324 | 1.918621929 | −1.27830796 |
| 0.124118831 | 0.956990986 | −0.656553816 |
| 0 | 0.086999181 | 0.086999181 |

TABLE 18
Section 15

| X | Y1 | Y2 |
|---|---|---|
| 112.1441977 | 0 | 0 |
| 112.0242034 | 0.043736237 | −0.012335862 |
| 111.6642205 | 0.174944948 | −0.047100563 |
| 111.066492 | 0.39138325 | −0.103172662 |
| 110.2332606 | 0.684079606 | −0.174944948 |
| 109.1690121 | 1.045183923 | −0.254567329 |
| 107.8759895 | 1.461238896 | −0.333068267 |
| 106.3620429 | 1.924394432 | −0.40820488 |
| 104.6316579 | 2.429043322 | −0.483341492 |
| 102.6938062 | 2.974064123 | −0.562963872 |
| 100.5574592 | 3.556092509 | −0.653800673 |
| 98.22934565 | 4.168399828 | −0.755851892 |
| 95.72067994 | 4.803135987 | −0.869117532 |
| 93.0426765 | 5.453572334 | −0.993597592 |
| 90.20654974 | 6.1152231 | −1.128170629 |
| 87.22463553 | 6.782481077 | −1.273958086 |
| 84.10814827 | 7.448617611 | −1.432081405 |
| 80.87166673 | 8.104661168 | −1.603662027 |
| 77.52976964 | 8.74164021 | −1.789821395 |
| 74.0959143 | 9.35394753 | −1.987195183 |
| 70.58467947 | 9.933733032 | −2.195783391 |
| 67.01176533 | 10.47538951 | −2.409978808 |
| 63.39062919 | 10.97330974 | −2.624174226 |
| 59.73921411 | 11.42188654 | −2.83612676 |
| 56.07209885 | 11.81775555 | −3.042472084 |
| 52.40498358 | 12.1530667 | −3.242088755 |
| 48.75356851 | 12.42109134 | −3.434976775 |
| 45.13243236 | 12.61397936 | −3.621136144 |
| 41.55951822 | 12.72275923 | −3.801688302 |
| 38.04828339 | 12.7407023 | −3.977754692 |
| 34.61442806 | 12.66556569 | −4.149335315 |
| 31.27253097 | 12.49398507 | −4.311944401 |
| 28.03604942 | 12.22708187 | −4.456610416 |
| 24.91956217 | 11.86934188 | −4.573240382 |
| 21.93764795 | 11.42749375 | −4.650619878 |
| 19.10152119 | 10.90714467 | −4.684263138 |
| 16.42351775 | 10.31165898 | −4.671927276 |
| 13.91485205 | 9.652251096 | −4.604640757 |
| 11.58673851 | 8.937892556 | −4.47567493 |
| 9.45039154 | 8.167461918 | −4.280544026 |
| 7.512539804 | 7.335351971 | −4.017005161 |
| 5.782154833 | 6.451655693 | −3.679451126 |
| 4.268208164 | 5.53655904 | −3.269003363 |
| 2.975185565 | 4.618098061 | −2.805847826 |
| 1.910937129 | 3.70412285 | −2.311291915 |
| 1.07770574 | 2.791269081 | −1.783092743 |
| 0.479977166 | 1.85486503 | −1.235829059 |
| 0.119994292 | 0.925189631 | −0.634736159 |
| 0 | 0.084108148 | 0.084108148 |

TABLE 19
Section 16

| X | Y1 | Y2 |
|---|---|---|
| 108.230203 | 0 | 0 |
| 108.1143966 | 0.042209779 | −0.011905322 |
| 107.7669777 | 0.168839117 | −0.045456685 |
| 107.1901107 | 0.377723408 | −0.099571787 |
| 106.3859603 | 0.660204238 | −0.168839117 |
| 105.3588557 | 1.008705492 | −0.245682561 |
| 104.1109614 | 1.410239545 | −0.321443703 |
| 102.6498537 | 1.857230283 | −0.393957939 |
| 100.9798617 | 2.344266196 | −0.466472175 |
| 99.10964376 | 2.870264983 | −0.543315619 |
| 97.0478584 | 3.431979736 | −0.630982083 |
| 94.80099938 | 4.022916644 | −0.729471568 |
| 92.37988974 | 4.635499593 | −0.838784073 |
| 89.79535249 | 5.26323477 | −0.958919598 |
| 87.05821066 | 5.901792968 | −1.088795842 |
| 84.18036956 | 6.545762675 | −1.229495106 |
| 81.17265222 | 7.188650081 | −1.382099692 |
| 78.04912857 | 7.821796768 | −1.547691902 |
| 74.82386852 | 8.436544321 | −1.727354039 |
| 71.5098597 | 9.027481229 | −1.917839197 |
| 68.12117205 | 9.587031379 | −2.119147374 |
| 64.67295778 | 10.10978326 | −2.325867062 |
| 61.17820453 | 10.59032536 | −2.532586749 |
| 57.65422912 | 11.02324617 | −2.737141833 |
| 54.11510148 | 11.40529879 | −2.936285406 |
| 50.57597385 | 11.7289071 | −3.128935168 |
| 47.05199844 | 11.98757728 | −3.315091117 |
| 43.55724518 | 12.17373323 | −3.494753254 |
| 40.10903092 | 12.27871653 | −3.669003881 |
| 36.72034326 | 12.29603336 | −3.838925299 |
| 33.40633445 | 12.22351912 | −4.00451751 |
| 30.1810744 | 12.05792691 | −4.161451304 |
| 27.05755074 | 11.80033903 | −4.301068266 |
| 24.0498334 | 11.45508468 | −4.413627677 |
| 21.1719923 | 11.02865768 | −4.488306517 |
| 18.43485047 | 10.52646954 | −4.520775578 |
| 15.85031322 | 9.951767163 | −4.508870256 |
| 13.42920358 | 9.315373569 | −4.443932134 |
| 11.18234457 | 8.625947176 | −4.3194674 |
| 9.120559204 | 7.882405682 | −4.131146847 |
| 7.250341297 | 7.079337576 | −3.87680587 |
| 5.580349265 | 6.226483577 | −3.551032959 |
| 4.119241525 | 5.34332512 | −3.154910416 |
| 2.871347285 | 4.456919758 | −2.707919678 |
| 1.844242659 | 3.574843604 | −2.230624483 |
| 1.040092251 | 2.693849752 | −1.720860227 |
| 0.463225269 | 1.790127557 | −1.192696837 |
| 0.115806317 | 0.892899174 | −0.612582949 |
| 0 | 0.081172652 | 0.081172652 |

TABLE 20
Section 17

| X | Y1 | Y2 |
|---|---|---|
| 104.842137 | 0 | 0 |
| 104.7299559 | 0.040888433 | −0.011532635 |
| 104.3934127 | 0.163553734 | −0.044033698 |
| 103.8346041 | 0.365899058 | −0.096454766 |
| 103.055627 | 0.639537036 | −0.163553734 |
| 102.0606751 | 0.977128717 | −0.237991651 |
| 100.8518453 | 1.366093045 | −0.311381147 |
| 99.43647644 | 1.799091071 | −0.381625379 |
| 97.81876226 | 2.270880688 | −0.451869611 |
| 96.00709014 | 2.780413474 | −0.526307528 |
| 94.00984743 | 3.324544165 | −0.611229659 |
| 91.83332466 | 3.896982233 | −0.706636004 |
| 89.48800606 | 4.490388729 | −0.812526562 |
| 86.98437582 | 5.098473123 | −0.928901334 |
| 84.33291818 | 5.717041732 | −1.054711898 |
| 81.54516576 | 6.340852447 | −1.191006677 |
| 78.63160277 | 6.963614741 | −1.33883409 |
| 75.60585869 | 7.576941243 | −1.499242559 |
| 72.48156301 | 8.172444581 | −1.673280507 |
| 69.27129677 | 8.744882649 | −1.857802668 |
| 65.98868946 | 9.286916498 | −2.052809043 |
| 62.64841898 | 9.793304019 | −2.253057525 |
| 59.26306637 | 10.25880311 | −2.453306006 |
| 55.84940639 | 10.67817166 | −2.651457645 |
| 52.42106851 | 11.0482644 | −2.844367177 |
| 48.99273063 | 11.36174239 | −3.030986181 |
| 45.57907065 | 11.6123151 | −3.211314657 |
| 42.19371805 | 11.79264357 | −3.385352605 |
| 38.85344756 | 11.89434045 | −3.554148445 |
| 35.57084025 | 11.91111519 | −3.7187506 |
| 32.36057401 | 11.84087096 | −3.87915907 |
| 29.23627833 | 11.68046249 | −4.031180169 |
| 26.21053426 | 11.4309382 | −4.166426525 |
| 23.29697127 | 11.09649178 | −4.275462348 |
| 20.50921884 | 10.68341376 | −4.347803422 |
| 17.8577612 | 10.19694625 | −4.379256063 |
| 15.35413097 | 9.640234499 | −4.367723428 |
| 13.00881236 | 9.023762734 | −4.304818146 |
| 10.8322896 | 8.355918321 | −4.184249689 |
| 8.835046887 | 7.635652839 | −4.00182437 |
| 7.023374759 | 6.857724183 | −3.755445348 |
| 5.405660585 | 6.031568143 | −3.439870516 |
| 3.990291735 | 5.176056305 | −3.056148294 |
| 2.781461895 | 4.317399203 | −2.623150268 |
| 1.786510015 | 3.462935786 | −2.160796444 |
| 1.007532937 | 2.609520791 | −1.666989979 |
| 0.448724346 | 1.734088946 | −1.15536035 |
| 0.112181087 | 0.86494763 | −0.593406496 |
| 0 | 0.078631603 | 0.078631603 |

TABLE 21
Section 18

| X | Y1 | Y2 |
|---|---|---|
| 103.6087354 | 0 | 0 |
| 103.497874 | 0.040407407 | −0.011396961 |
| 103.16529 | 0.161629627 | −0.043515669 |
| 102.6130554 | 0.361594486 | −0.095320037 |
| 101.8432425 | 0.632013286 | −0.161629627 |
| 100.8599956 | 0.965633414 | −0.235191829 |
| 99.66538692 | 1.350021822 | −0.307717944 |
| 98.26666899 | 1.777925899 | −0.377135797 |
| 96.6679862 | 2.244165208 | −0.44655365 |
| 94.87762725 | 2.747703662 | −0.520115852 |
| 92.90388085 | 3.285432999 | −0.604038927 |
| 90.7529635 | 3.851136694 | −0.698322876 |
| 88.43523609 | 4.437562137 | −0.802967699 |
| 85.96105949 | 5.038492802 | −0.917973396 |
| 83.34079457 | 5.649784341 | −1.042303878 |
| 80.5858383 | 6.266256316 | −1.176995234 |
| 77.70655154 | 6.881692204 | −1.323083551 |
| 74.71640344 | 7.487803306 | −1.481604916 |
| 71.62886312 | 8.076300923 | −1.653595417 |
| 68.45636364 | 8.642004619 | −1.835946791 |
| 65.21237414 | 9.17766178 | −2.028659039 |
| 61.91139983 | 9.678091972 | −2.226551723 |
| 58.56587376 | 10.13811476 | −2.424444408 |
| 55.19237334 | 10.5525497 | −2.620264918 |
| 51.80436769 | 10.91828853 | −2.810904991 |
| 48.41636205 | 11.22807865 | −2.99532854 |
| 45.04286162 | 11.47570353 | −3.173535565 |
| 41.69733556 | 11.65391056 | −3.345526066 |
| 38.39636125 | 11.75441103 | −3.51233613 |
| 35.15237174 | 11.77098843 | −3.675001844 |
| 31.97987226 | 11.70157057 | −3.833523209 |
| 28.89233195 | 11.54304921 | −3.983755876 |
| 25.90218385 | 11.29646042 | −4.117411144 |
| 23.02289709 | 10.96594855 | −4.225164229 |
| 20.26794082 | 10.55773014 | −4.296654256 |
| 17.6476759 | 10.0769856 | −4.327736877 |
| 15.1734993 | 9.526823219 | −4.316339916 |
| 12.85577189 | 8.917603855 | −4.254174675 |
| 10.70485454 | 8.25761621 | −4.135024629 |
| 8.731108131 | 7.545824198 | −3.95474543 |
| 6.940749183 | 6.777047382 | −3.711264902 |
| 5.342066396 | 5.960610547 | −3.399402608 |
| 3.943348469 | 5.115163266 | −3.020194636 |
| 2.74873975 | 4.266607723 | −2.592290559 |
| 1.765492851 | 3.42219653 | −2.135376036 |
| 0.995679947 | 2.578821424 | −1.647378893 |
| 0.443445387 | 1.713688483 | −1.141768264 |
| 0.110861347 | 0.854772067 | −0.586425442 |
| 0 | 0.077706552 | 0.077706552 |

TABLE 22
Section 19

| X | Y1 | Y2 |
|---|---|---|
| 102.8339186 | 0 | 0 |
| 102.7238863 | 0.040105228 | −0.011311731 |
| 102.3937894 | 0.160420913 | −0.043190246 |
| 101.8456846 | 0.358890376 | −0.094607205 |
| 101.0816286 | 0.627286903 | −0.160420913 |
| 100.1057347 | 0.958412121 | −0.233432995 |
| 98.92005966 | 1.339925959 | −0.305416738 |
| 97.53180176 | 1.764630043 | −0.374315464 |
| 95.94507439 | 2.227382677 | −0.443214189 |
| 94.16810428 | 2.727155521 | −0.516226271 |
| 92.20911813 | 3.260863559 | −0.599521745 |
| 90.07428598 | 3.822336754 | −0.693100611 |
| 87.77389122 | 4.404376734 | −0.796962869 |
| 85.31821724 | 5.000813461 | −0.911108519 |
| 82.71754744 | 5.607533581 | −1.034509221 |
| 79.98319355 | 6.219395397 | −1.168193315 |
| 77.12543895 | 6.830228873 | −1.313189141 |
| 74.15765206 | 7.431807297 | −1.470525036 |
| 71.09320128 | 8.015903955 | −1.641229341 |
| 67.9444267 | 8.57737715 | −1.822217038 |
| 64.7246967 | 9.109028509 | −2.013488126 |
| 61.44840806 | 9.605716336 | −2.209900911 |
| 58.12790083 | 10.06229893 | −2.406313695 |
| 54.77962844 | 10.47363461 | −2.600669801 |
| 51.4169593 | 10.83663834 | −2.789884212 |
| 48.05429016 | 11.14411176 | −2.972928587 |
| 44.70601777 | 11.38988482 | −3.149802927 |
| 41.38551054 | 11.56675916 | −3.320507232 |
| 38.10922189 | 11.66650806 | −3.48606984 |
| 34.8894919 | 11.68296149 | −3.647519093 |
| 31.74071731 | 11.61406277 | −3.804854988 |
| 28.67626654 | 11.45672687 | −3.95396417 |
| 25.70847965 | 11.21198214 | −4.086619925 |
| 22.85072505 | 10.88394194 | −4.1935672 |
| 20.11637116 | 10.47877631 | −4.264522604 |
| 17.51570135 | 10.00162692 | −4.29537278 |
| 15.06002738 | 9.455578815 | −4.284061049 |
| 12.75963262 | 8.850915374 | −4.222360698 |
| 10.62480047 | 8.195863312 | −4.104101691 |
| 8.66581432 | 7.489394292 | −3.925170673 |
| 6.888844207 | 6.726366616 | −3.683510964 |
| 5.302116843 | 5.916035337 | −3.373980869 |
| 3.913858942 | 5.076910561 | −2.997608727 |
| 2.72818386 | 4.234700768 | −2.572904643 |
| 1.752289973 | 3.396604331 | −2.119407062 |
| 0.988233958 | 2.559536234 | −1.635059306 |
| 0.440129172 | 1.700873014 | −1.133229783 |
| 0.110032293 | 0.848379828 | −0.582039979 |
| 0 | 0.077125439 | 0.077125439 |

The above description is that of a current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A wind turbine blade comprising:
a first end adapted to be attached to a hub of a wind turbine and a second end distal from the first end, a distance between the first end and the second end defining a span of the wind turbine blade;
a root section adjacent the first end, at least one cross section of the root section having a root section chord length, at least one cross section of the root section having a root section blade setting angle;
a transition section adjacent the root section, at least one cross section of the transition section having a transition section chord length, at least one cross section of the transition section having a transition section blade setting angle; and
a conventional section adjacent the transition section, at least one cross section of the conventional section having a conventional section chord length calculated using conventional formulas, at least one cross section of the conventional section having a conventional section blade setting angle calculated using conventional formulas;
wherein the root section chord length is greater than a root section chord length calculated using conventional formulas by a factor of approximately 1.3 and the transition section chord length is between a value approximately equal to the root section chord length and a value approximately equal to the conventional section chord length.

2. The wind turbine blade of claim 1 wherein the root section blade setting angle is greater than a blade setting angle calculated using conventional formulas by a factor of approximately 1.3 and the transition section blade setting angle is between a value approximately equal to the root section blade setting angle and a value approximately equal to the conventional section blade setting angle.

3. The wind turbine blade of claim 2 wherein the root section is located between the first end of the wind turbine blade and approximately 20% to 50% of the span, the transition section is located between approximately 20% to 50% and approximately 30% to 60% of the span and the conventional section is located between approximately 30% to 60% and approximately 85% of the span to the second end of the wind turbine blade.

4. The wind turbine blade of claim 3 wherein the root section is located between approximately the first end of the wind turbine blade and approximately 30% to 40% of the span, the transition section is located between approximately 30% to 40% and approximately 40% to 50% of the span, the conventional section is located between approximately 40% to 50% and approximately 95% of the span and a tip section is located between approximately 95% of the span and approximately the second end of the wind turbine blade.

5. The wind turbine blade of claim 4 wherein the tip section includes a winglet structure.

6. The wind turbine blade of claim 5 wherein the tip section makes an angle between approximately 20° and 50° relative to the conventional section of the wind turbine blade.

7. The wind turbine blade of claim 6 wherein the tip section forms an angle between approximately 30° and 40° relative to the conventional section of the wind turbine blade.

8. The wind turbine blade of claim 7 wherein the tip section forms an angle of approximately 35° relative to the conventional section of the wind turbine blade.

9. The wind turbine blade of claim 3 wherein a majority of the cross sections of the root section have a chord length equal to the root section chord length and a blade setting angle equal to the root section blade setting angle.

10. The wind turbine blade of claim 4 wherein a majority of the cross sections of the root section have a chord length equal to the root section chord length and a blade setting angle equal to the root section blade setting angle.

11. A wind turbine blade comprising:
a first end adapted to be attached to a hub of a wind turbine and a second end distal from the first end, a distance between the first end and second end defining a span of the wind turbine blade,
wherein at least one cross section of the blade in a section located between approximately 40% to 60% and approximately 90% of the blade span to the second end has a first blade setting angle calculated using conventional formulas,
wherein at least one cross section of the blade in a section located between approximately the first end and approximately 30% to 50% of the blade span has a second blade setting angle, the second blade setting angle being greater than a blade setting angle calculated using conventional formulas by a factor of approximately 1.3,
wherein at least one cross section of the blade in a section located between approximately 30% to 50% and approximately 40% to 60% of the blade span has a blade setting angle between the first blade setting angle and the second blade setting angle.

12. The wind turbine blade of claim 11 wherein at least one cross section of the blade in a section located between approximately 60% to 70% and approximately 90% of the blade span to the second end has a first chord length calculated using conventional formulas,
wherein at least one cross section of the blade in a section located between approximately the first end to 20% and approximately 30% to 40% of the blade span has a second chord length greater than a chord length calculated using conventional formulas by a factor of approximately 1.3,
wherein at least one cross section of the blade in a section located between approximately 30% to 40% and approximately 60% to 70% of the blade span has a chord length between the first chord length and the second chord length.

13. The wind turbine blade of claim 12 wherein at least one cross section of the blade in a section located between approximately 50% and approximately 95% of the blade span has the first blade setting angle,
wherein at least one cross section of the blade in a section located between approximately 10% and approximately 40% of the span has the second blade setting angle,
wherein at least one cross section of the blade in a section located between approximately 40% and approximately 50% of the blade span has a blade setting angle between the first blade setting angle and the second blade setting angle,
wherein at least one cross section of the blade in a section located between approximately 65% and approximately 95% of the blade span has the first chord length,
wherein at least one cross section of the blade in a section located between approximately 10% and approximately 35% of the blade span has the second chord length,
wherein at least one cross section of the blade in a section located between approximately 35% and approximately 65% of the blade span has a chord length between the first chord length and the second chord length,
wherein the blade has a winglet in a section located between approximately 95% of the blade span and approximately the second end.

14. The wind turbine blade of claim 13 wherein the winglet forms an angle between approximately 30° and 40° with a plane of rotation of the wind turbine blade.

15. The wind turbine blade of claim 14 wherein the winglet forms an angle of approximately 35° with a plane of rotation of the wind turbine blade.

16. A wind turbine blade with cross sections spaced along a span of the blade, each cross section including a variable distance (X) from a leading edge of the blade along a chord line, a corresponding distance (Y1) perpendicular to the chord line between the chord line and a top surface of the blade at the variable distance (X) and a corresponding distance (Y2) perpendicular to the chord line between the chord line and a bottom surface of the blade at the variable distance (X),
wherein at least one cross section of the blade has values X, Y1 and Y2 corresponding substantially to the values in each of Tables 4-22.
